(19) United States
(12) Patent Application Publication
(10) Pub. No.: US 2025/0171877 A1
(43) Pub. Date: May 29, 2025

(54) PROCESS AND CIRCUIT FOR SELECTIVE ADSORPTION AND DESORPTION OF LITHIUM FROM MULTIVALENT SALT-CONTAINING SOLUTIONS

(71) Applicant: ILiAD IP COMPANY, LLC, Carlesbad, CA (US)

(72) Inventor: Charles R. Marston, Midland, MI (US)

(73) Assignee: ILiAD IP COMPANY, LLC, Carlesbad, CA (US)

(21) Appl. No.: 18/933,978

(22) Filed: Oct. 31, 2024

Related U.S. Application Data
(60) Provisional application No. 63/604,057, filed on Nov. 29, 2023.

(51) Int. Cl. C22B 26/12; C22B 3/24

(52) U.S. Cl. CPC C22B 26/12; C22B 3/24

(57) ABSTRACT

This invention generally relates to a process and circuit for the selective adsorption and desorption of lithium from natural and synthetic multivalent salt solutions, such as sulfate-containing solutions, using a LADH lithium selective adsorbent in a CCAD process and circuit. During the CCAD process, lithium ions load selectively and in high capacity into the LADH lithium selective adsorbent from feedstock solutions heavy in salts of both monovalent and multivalent anions. The inventive CCAD process/circuit displaces the high multivalent salt-containing feedstock solution with a strong monovalent salt solution to initiate a metathesis reaction of bound multivalent salts. The inventive process/circuit then deintercalates the formed LiCl from the LADH lithium selective adsorbent with water or a dilute salt solution.

### CROSS-REFERENCE TO RELATED APPLICATIONS

This application claims the benefit of U.S. Provisional Patent Application No. 63/604,057 filed on Nov. 29, 2023, and incorporates by reference the provisional application in its entirety into this document as if fully set out at this point.

### BACKGROUND OF THE INVENTION

### 1. Field of the Invention

The subject matter disclosed herein relates to a process and circuit for selective adsorption and desorption of lithium from multivalent salt-containing solutions, and, more particularly, to a process and circuit for recovering lithium from a natural or synthetic solution containing high concentrations of sulfate using continuous countercurrent adsorption and desorption (“CCAD”) with a lithium selective adsorbent.

### 2. Description of the Related Art

The growing demand for lithium in various applications, particularly lithium-ion batteries, means that lithium-bearing solutions, brines, and other feedstocks are becoming increasingly attractive as new energy resources. Lithium-bearing solutions are expected to provide increasingly higher amounts of lithium to the battery metals market, particularly through new developments in direct lithium extraction (“DLE”) processes. Until recently, most of the lithium was recovered from hard rock ore leach solutions and continental brines in South America, China, and Australia using solar evaporative processes. In some instances, the primary product of such brine processing is potassium, with lithium being produced as a side product.

As lithium has gained importance for use in various applications, there are continuing efforts to develop simple, inexpensive, and efficient DLE processes for recovering lithium from lithium-containing solutions. There have been significant efforts in using layered lithium aluminates, typically of the formula LiX/Al (OH)₃. While lithium aluminum double hydroxide (“LADH”) adsorbents are known to selectively adsorb lithium ions from solutions at a moderate pH (e.g., 5-7), multivalent ions, such as sulfate anions, inhibit the deintercalation of lithium ions from LADH adsorbents thereby strongly limiting the reversible lithium loading capacity. Under normal deintercalation conditions using water or dilute salt solutions as an eluant, LADH adsorbents loaded by adsorption of lithium from highly concentrated brines with primarily multivalent anions, release only about 40% to about 50% of the adsorbed lithium ions, making LADH adsorbents generally uneconomical and ineffective in lithium recovery from sulfate-containing solutions.

WO2023/040534 discloses a method for adsorbing lithium in a solution containing carbonate or/and sulfate by treating the loaded adsorbent with a low pH brine to convert the sulfate to bisulfate and the carbonate to bicarbonate. The method of WO2023/040534 introduces chemicals, such as mineral acids, organic acids, and phosphates, to the lithium product. These chemicals increase the complexity of the lithium recovery process and significantly increase the operating cost in pursuit of high-purity lithium salts for battery-grade products. In addition, the lithium products of WO2023/040534 are lithium bisulfate (LiHSO₄) or lithium bicarbonate (LiHCO₃), rather than LiCl, which complicates downstream purification processes. Moreover, the limited solubility of LiHCO₃ and Li₂CO₃ could hamper the release of lithium from the LADH adsorbent through chemisorption.

### SUMMARY OF THE INVENTION

Accordingly, it is an object of the inventive process and circuit to render LADH adsorbents commercially suitable for the selective recovery of lithium from high multivalent salt-containing solutions, such as those generated in lithium clay, spodumene, hard rock processing, battery metal recycling applications, and other leachate solutions.

The invention relates to a process and circuit for recovering lithium from a natural or synthetic solution having a high concentration of multivalent salt anions, such as sulfate, by contacting the solution with a LADH lithium selective adsorbent using continuous countercurrent adsorption and desorption. The inventive CCAD process/circuit displaces the multivalent salt-containing feedstock solution with a strong monovalent salt solution to initiate a metathesis reaction and then deintercalates the formed LiCl with water or a dilute salt solution. The invention provides a circuit and process that allows the ready release of lithium ions from the LADH adsorbent to levels equivalent to those observed in chloride-containing solutions.

In general, in a first aspect, the invention relates to a process for selective recovery of lithium from a strong multivalent feedstock solution. The process concentrates the lithium in the feedstock solution by cyclically and sequentially flowing the feedstock solution through a continuous countercurrent adsorption and desorption circuit to form an enhanced lithium product stream. The continuous countercurrent adsorption and desorption circuit has a central multi-port valve system with a plurality of process zones, and each process zone has an adsorbent bed or column containing a lithium selective adsorbent. The plurality of process zones include a monovalent displacement zone positioned upstream with respect to fluid flow of and in fluid communication with a multivalent displacement zone, the multivalent displacement zone is positioned upstream with respect to fluid flow of and in fluid communication with an adsorption loading zone, the adsorption loading zone is positioned upstream with respect to fluid flow of and in fluid communication with a strip displacement zone, the strip displacement zone is positioned upstream with respect to fluid flow of and in fluid communication with a lithium product strip zone, and the lithium product strip zone is in fluid communication with the monovalent displacement zone. The process recovers the lithium from the enhanced lithium product stream.

In an embodiment, the strong multivalent feedstock solution is a leachate solution from ore, hard rock, clay, or spodumene, a solution from a battery recycling process, mother liquors, a pregnant leach or liquor solution, or any other multivalent anion-containing lithium solution.

In an embodiment, the strong multivalent feedstock solution is a strong sulfate feedstock solution.

In one embodiment, the strong sulfate feedstock solution has a concentration of about 15% to about 25% sulfate (and any range or value therebetween).

In an embodiment, the strong sulfate feedstock solution has a concentration of greater than about 25,000 mg/kg of sulfate (and any range or value therebetween), more particularly, a concentration of between about 50,000 mg/kg and about 150,000 mg/kg of sulfate.

In an embodiment, the strong multivalent feedstock solution has a temperature of about 5° C. to about 100° C. (and any range or value therebetween), and more particularly, a temperature of about 5° C. to about 50° C. or of about 50° C. to about 100° C.

In an embodiment, the process also includes eluting the strong multivalent feedstock solution from the adsorbent bed or column containing the lithium selective adsorbent in the monovalent displacement zone with a strong monovalent salt solution to covert bound multivalent ions to monovalent ions, and eluting the adsorbent bed or column containing the lithium selective adsorbent in the monovalent displacement zone with a low salt aqueous solution.

In an embodiment, the strong monovalent salt solution has between about 10% and about 30% sodium chloride (and any range or value therebetween), and more particularly, a 20% strong monovalent salt solution.

In an embodiment, the strong monovalent salt solution is a sodium chloride salt solution, a potassium chloride salt solution, or a combination thereof.

In an embodiment, the process also includes the steps of:
a) displacing the strong multivalent feedstock solution from a freshly loaded adsorbent bed or column in the monovalent displacement zone using an elution volume of a lithium-containing eluant solution or a portion of a lithium product eluate from the lithium product strip zone to a monovalent solution vessel;
b) displacing bound multivalent ions from the adsorbent bed or column in the multivalent displacement zone using a strong monovalent solution from the monovalent solution vessel;
c) displacing an elution volume of a strong multivalent displacement solution from the adsorbent bed or column in the multivalent displacement zone to a combined high multivalent solution vessel;
d) passing a combined strong multivalent feedstock solution/strong multivalent displacement solution through the adsorption loading zone with a predetermined contact time sufficient to completely or almost completely load the adsorbent bed or column in the adsorption loading zone and forming a lithium-depleted, high multivalent raffinate;
d) displacing a latent eluate solution from the adsorbent bed or column in the strip displacement zone with a portion of the lithium-depleted, high multivalent raffinate from the adsorbent loading zone and into a lithium product strip zone;
e) flowing a lithium strip solution through the lithium product strip zone stripping a portion of lithium adsorbed on the adsorbent bed or column in the lithium product strip zone; and
f) collecting a portion of the eluant having high lithium concentration as the enhanced lithium product solution.

In an embodiment, the lithium product eluate includes neutral salts and water at a concentration of up to about 1000 mg/kg lithium and at a temperature of between about 5° C. to about 100° C. (and any range or value therebetween).

In an embodiment, the process also includes selectively converting the lithium chloride in the enhanced lithium product stream to lithium carbonate, lithium hydroxide, or both.

In general, in a second aspect, the invention relates to a continuous countercurrent adsorption desorption circuit configured for the selective adsorption and recovery of lithium from a strong multivalent feedstock solution. The circuit has a central multi-port valve system with a plurality of process zones, and each process zone includes a plurality of adsorbent beds or columns with a lithium selective adsorbent. The plurality of process zones are a monovalent displacement zone positioned upstream with respect to fluid flow of and in fluid communication with a multivalent displacement zone, the multivalent displacement zone positioned upstream with respect to fluid flow of and in fluid communication with an adsorption loading zone, the adsorption loading zone positioned upstream with respect to fluid flow of and in fluid communication with a strip displacement zone, the strip displacement zone positioned upstream with respect to fluid flow of and in fluid communication with a lithium product strip zone, and the lithium product strip zone in fluid communication with the monovalent displacement zone.

In an embodiment, the strong multivalent feedstock solution is a leachate solution from ore, hard rock, clay, or spodumene, a solution from a battery recycling process, mother liquors, a pregnant leach or liquor solution, or any other multivalent anion-containing lithium solution.

In an embodiment, the strong multivalent feedstock solution is a strong sulfate feedstock solution having a concentration of greater than about 25,000 mg/kg sulfate.

In an embodiment, the circuit includes:
a strong monovalent solution vessel in fluid communication with the adsorbent bed or column in the monovalent displacement zone and the adsorbent bed or column in the multivalent displacement zone;
a combined strong multivalent feedstock solution/strong multivalent displacement solution vessel in fluid communication with the adsorbent bed or column in the multivalent displacement zone and the adsorbent bed or column in the adsorption loading zone;
a lithium-depleted, high multivalent solution vessel in fluid communication with the adsorbent bed or column in the adsorption loading zone and the adsorbent bed or column in the strip displacement zone;
a lithium strip solution vessel in fluid communication with the adsorbent bed or column in the strip displacement zone and the adsorbent bed or column in the lithium product strip zone; and
an enhanced lithium product solution vessel in fluid communication with the adsorbent bed or column in the lithium product strip zone and with the adsorbent bed or column in the monovalent displacement zone.

### BRIEF DESCRIPTION OF THE DRAWINGS

The above and other objects and advantages of this invention may be more clearly seen when viewed in conjunction with the accompanying drawing wherein:

FIG. 1 is a process diagram of an example of a CCAD lithium recovery circuit in accordance with an illustrative embodiment of the invention disclosed herein.

FIG. 2 graphically illustrates the LADH lithium loading (intercalation) curve from a lithium-bearing sodium sulfate brine.

FIG. 3 graphically illustrates sulfate inhibition of lithium elution demonstrating the poor reversible lithium capacity of the LADH adsorbent when loaded (intercalated) with lithium from high sulfate brines.

FIG. 4 graphically illustrates an improved lithium elution breakthrough curve showing the increased reversible capacity of the LADH adsorbent after sulfate displacement with sodium chloride brine and then eluted using standard deintercalation conditions of low salt aqueous solutions in accordance with an illustrative embodiment of the invention disclosed herein.

### DETAILED DESCRIPTION OF THE INVENTION

While this invention is susceptible to embodiment in many different forms, there are shown in the drawings and will herein be described in detail some specific embodiments of the invention. It should be understood, however, that the present disclosure is to be considered an exemplification of the principles of the invention and is not intended to limit the invention to the specific embodiments so described.

This invention generally relates to a process and circuit for the selective adsorption and desorption of lithium from natural and synthetic multivalent salt solutions, such as sulfate-containing solutions, using a LADH lithium selective adsorbent in a CCAD process and circuit. During the CCAD process, lithium ions load selectively and in high capacity into the LADH lithium selective adsorbent from brines heavy in salts of both monovalent and multivalent anions; however, as noted above, deintercalation with water or dilute salt solutions is inhibited by intercalated multivalent anions. The inventive process employs mass action of highly concentrated chlorine solution to displace sulfate from the LADH lithium selective adsorbent. The inventive CCAD process/circuit displaces the high multivalent salt-containing feedstock solution with a strong monovalent salt solution to initiate a metathesis reaction of intercalated lithium sulfate salts to lithium chloride salts. The strong monovalent salt species can include sodium chloride (NaCl), and/or potassium chloride (KCl) at high concentrations (e.g., about 10% to about 30% salt and any range or value therebetween).

$${Li}_{2} {SO}_{4} + 2 X Cl \to {X}_{2} {SO}_{4} + 2 Li Cl , \qquad Equation 1$$

$$where$$

$$X is {Na}^{+} or {K}^{+}$$

The inventive process/circuit then deintercalates the formed LiCl with water or a dilute salt solution.

The sulfate-containing feedstock solution can be from any lithium resource, such as leachate solutions from ore, hard rock, clay, or spodumene lithium mining and beneficiation, solutions from battery recycling processes, mother liquors, pregnant leach or liquor solutions (PLS), or any other multivalent anion-containing lithium solution. Clay, spodumene, battery metal recycling, and other PLS feedstock solutions are leached with sulfuric acid (H₂SO₄) and concentrated as sulfate-rich solutions, which makes LADH adsorbents effective adsorbents, but standard elution techniques are ineffective in desorption of lithium from the LADH adsorbent.

The feedstock solution generally includes high concentrations of sulfate salts of sodium, potassium, and calcium, such as having about 15% to about 25% sulfate concentration (and any range or value therebetween) or having a concentration greater than about 25,000 mg/kg, or, more particularly, between about 50,000 mg/kg and about 150,000 mg/kg (and any range or value therebetween) of the multivalent salt.

The feedstock solution can be passed directly to the CCAD circuit with minimal pretreatment or may be subject to one or more preliminary treatment steps, including the removal of solids, organic materials, and certain problem metals or metals of commerce (e.g., iron, manganese, zinc, silicon, etc.). For example, granular media filtration (“GMF”) can be used to reduce total suspended solids (“TSS”) to below 10 ppm before introducing the solution to the CCAD circuit. Other feedstock solutions may require additional pretreatment processes to prevent solids that are close to saturation (e.g., iron, manganese, zinc, silicon, etc.) from precipitating from the feedstock solutions. In addition, other feedstock solutions may require pretreatment processing to remove any residual organic material before being passed to the CCAD circuit. The bulk of the organic material can be removed by a device, such as an oil-water separator, and any remaining organic materials can be removed with a mixed bed GMF that includes activated carbon as part of the mixed bed.

Just prior to treatment by the inventive process and circuit, the feedstock solution preferably has a pH between about 5 and about 7 (and any range or value therebetween). If necessary, the pH of the feedstock solution can be adjusted with sulfuric acid. The feedstock solution can have a temperature of about 5° C. to about 100° C. (and any range or value therebetween); higher temperature solutions (about 50° C. to about 100° C.) improve the kinetic response of the lithium selective adsorbent; however, lower temperature solutions can also be successfully treated (about 5° C. to about 50° C.) using the inventive process and circuit. The metathesis of the inventive CCAD process can be accomplished under alkaline, neutral, or acidic conditions, does not require any reagents other than a strong monovalent salt solution, and additional process heat is not required to drive the reaction.

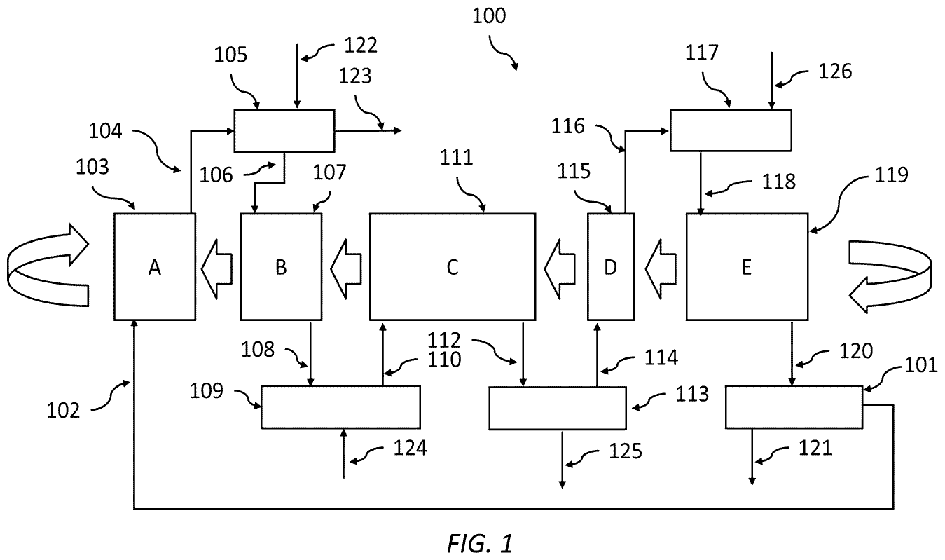

Referring to FIG. 1, the CCAD circuit 100 includes a series of sequential steps in a cyclic process. The CCAD circuit 100 has a plurality of adsorption beds or columns, each containing a lithium selective adsorbent. The lithium selective adsorbent in the adsorbent beds can be any of the lithium aluminum intercalate (“LAI”) forms known in the art, such as lithium aluminum layered double hydroxide chloride (Li_{X}Al₂(OH)₆Cl_{X}), Gibbsite-based (or Gibbsite's common polymorphs, e.g., Bayerite, Boehmite, and Nordstrandite) lithium aluminum layered double hydroxide, lithium aluminum intercalate (LiAl₂(OH)₆Cl) crystals in macroporous, polymeric resin beads or other suitable adsorbent support.

The adsorption beds are sequentially subjected to individual process zones as part of the CCAD circuit 100. Each of the process zones includes one or more of the adsorbent beds configured in parallel, in series, or in combinations of parallel and series, flowing either in up-flow or down-flow modes. Fluid flow through the CCAD circuit 100 is controlled by pumping flow rates and/or predetermined indexing of a central multi-port valve system, of the adsorbent beds, or both, creating a process where the adsorption beds continually cycle through the individual process zones.

As exemplified in FIG. 1, the CCAD circuit 100 includes a monovalent displacement zone A, a multivalent displacement zone B, an adsorption loading zone C, a strip displacement zone D, and a lithium product strip zone E.

A portion of high lithium concentration product eluate 102 is pumped from a lithium product vessel 101 in the lithium product strip zone E to an adsorbent bed(s) 103 in the monovalent displacement zone A. The elution volume of high lithium concentration product eluate 102 drawn from the product strip zone E is at least enough to displace one adsorbent bed void fraction 104 during an index time (the time interval between rotary valve indexes) from the adsorbent bed(s) 103 to a monovalent solution vessel 105 in the monovalent displacement zone A.

In order to displace bound multivalent ions, e.g., sulfate anions, a strong monovalent solution 106 (e.g., about 10% to about 30% sodium chloride (NaCl) or potassium chloride (KCl)) from the monovalent solution vessel 105 initiates a salt metathesis of bound lithium sulfate and/or lithium sodium sulfate to lithium chloride in an adsorbent bed(s) 107 in the multivalent displacement zone B. A strong monovalent solution makeup-up 122 can be fluidly connected to the vessel 105, and optionally, a strong monovalent solution bleed 123 can be pumped from the vessel 105 to a combined high multivalent solution vessel 109. An elution volume of lithium-bearing high multivalent solution 108 is displaced from the adsorbent bed(s) 107 in the multivalent displacement zone B to the combined high multivalent solution vessel 109.

A source of multivalent feedstock solution 124, e.g., a high sulfate-containing feedstock solution, is supplied to the combined high multivalent solution vessel 109. The combined high multivalent feedstock solution 110 is pumped from the vessel 109 to an adsorbent bed(s) 111 in the adsorption loading zone C with a predetermined contact time sufficient to completely or almost completely load or exhaust the lithium selective adsorbent in the adsorbent bed(s) 111. The loading zone C is sized such that under the steady-state operation of the CCAD circuit 100, the complete lithium adsorption mass transfer zone is captured within the loading zone C. The lithium-depleted, high multivalent raffinate 112 exiting the loading zone C is sent to a depleted, high multivalent raffinate vessel 113. The steady-state operation achieves maximum lithium loading without significant lithium leaving with the lithium-depleted raffinate 112 as tails.

A portion of the lithium-depleted, high multivalent raffinate 125 is pumped from the vessel 113 to be returned to the multivalent brine aquifer, e.g., via reinjection, and another portion of the raffinate 114 is pumped from the vessel 113 to an adsorbent bed(s) 115 in the strip displacement zone D to displace latent eluate solution 116, which is carried forward as entrained fluid within the adsorbent bed 115 transitioning from the strip displacement zone D into an adsorbent bed(s) 119 in the lithium product strip zone E in the cyclic process, back to the inlet of the product strip zone E. The elution volume of the displacement raffinate 114 drawn from the vessel 113 to displace latent eluate solution 116 to a lithium product strip vessel 117 is at least enough to displace one adsorbent bed 115 void fraction during the rotary valve index time in the strip displacement zone D.

A lithium strip solution makeup-up 126 can be fluidly connected to the lithium product strip vessel 117. An eluant (lithium strip solution) 118 is pumped from the lithium product strip vessel 117 countercurrent to the process zone advance (fluid flow is illustrated as right to left, while the process zone movement is illustrated as left to right) into an adsorbent bed(s) 119 in the lithium strip zone E to produce an enhanced lithium product stream 120. The lithium strip solution 118 comprises a low-concentration lithium product eluant (as neutral salts, generally lithium chloride) in water at a concentration from about 0 mg/kg to about 1000 mg/kg lithium and at temperatures of about 5° C. to about 100° C. Properly tuned, the CCAD circuit 100 recovers between about 90% and about 97% of the lithium from the feedstock solution and produces the enhanced lithium chloride product stream 120 having a concentration 10- to 50-fold that of the feedstock solution with a greater than 99.9% rejection of hardness ions and most other solution components. The enhanced lithium product stream 120 is pumped from the adsorbent bed(s) 119 in the lithium strip zone E to the lithium product vessel 101.

The production of this high-purity lithium, without the need for extra rinse water, is an extremely cost-effective process of obtaining commercially valuable and substantially pure lithium chloride, suitable for conversion to battery-grade carbonate or hydroxide. After leaving the CCAD circuit 100, the enhanced lithium chloride product stream 121 in FIG. 1 is passed to a lithium carbonate and/or a lithium chloride conversion circuit. The conversion circuit removes selected remaining impurities, dewaters, and softens the lithium chloride product stream 121, and further concentrates lithium in the lithium chloride product stream 121 before crystallization or electrolysis.

The portion of high lithium concentration product eluate 102 that is recycled and displaces the monovalent salt solution 104 from the monovalent salt solution displacement zone A is enough fluid to completely displace multivalent salts from the adsorbent bed(s) 103 before the adsorbent bed(s) 119 enters the lithium strip zone E. This means that the displaced lithium-bearing multivalent feedstock solution 108 may be recycled into the combined high multivalent solution vessel 109 and introduced to the adsorbent bed(s) 111 in the loading zone C with the feedstock solution 124. Depending on the tuning parameters of the CCAD circuit 100, the low lithium concentration in the recycled displacement feedstock 108 could significantly increase the effective concentration of lithium entering the loading zone C. This enhanced feed concentration results in significantly increased lithium capacity and greater lithium recovery efficiency, especially in the case of feedstock solutions with low lithium concentrations (under 200 mg/kg).

### EXAMPLES

The process for the selective adsorption and desorption of lithium from natural and synthetic multivalent salt solutions using a LADH lithium selective adsorbent in a CCAD circuit disclosed herein is further illustrated by the following examples, which are provided for the purpose of demonstration rather than limitation.

Example 1. This example demonstrates that LADH adsorbents strongly bind lithium ions from strong sulfate solutions but do not deintercalate (elute) lithium readily when using standard deintercalation conditions of low salt aqueous solutions.

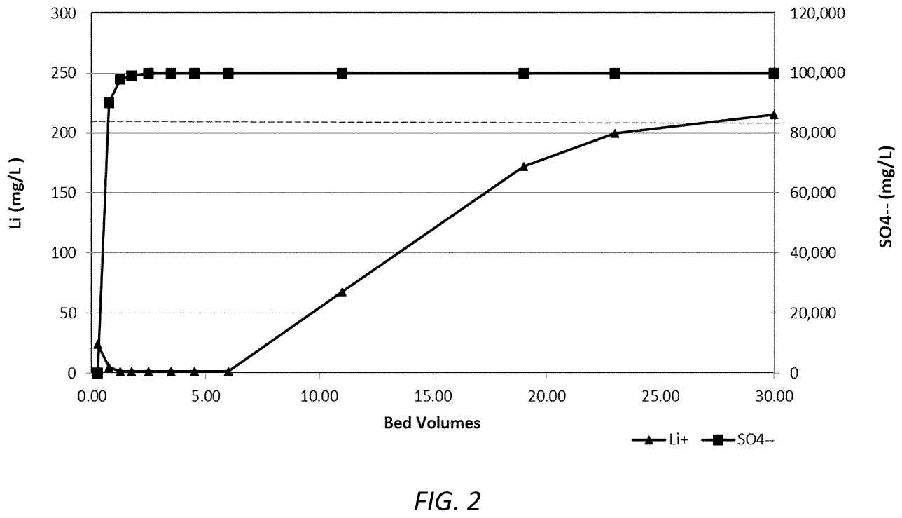

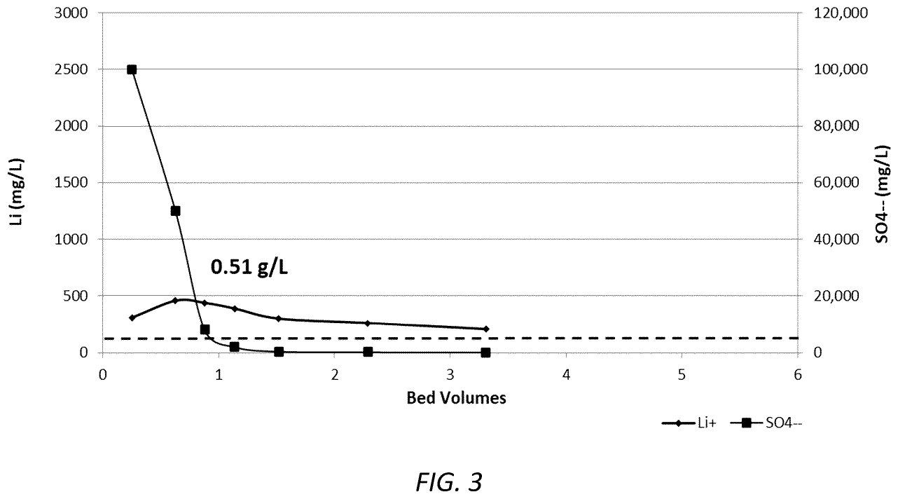

A 1-inch diameter jacketed glass column was filled with 250 mL of a proprietary LADH lithium selective adsorbent. At 74° C., a 20% sodium sulfate (˜100,000 mg/L SO₄²⁻) solution containing 240 mg/L lithium as lithium chloride at 75° C. and a pH of about 5.5 was passed through the column at a flow rate of 25 ml/min (6.0 BV/hr), and the loading or intercalation curve was recorded and analyzed for lithium and sulfate. The lithium and sulfate loading curves in FIG. 2 were analyzed to show that the LADH adsorbent captured/bound lithium ions to a level of about 3 g of lithium per liter of adsorbent. After 30 bed volumes (BV) of the lithium-bearing sulfate solution, the feed was switched to water having 140 mg/kg lithium as lithium chloride at 74° C. and a flow rate of 20 ml/min (4.8 BV/hr) to strip or deintercalate the lithium and sulfate loaded LADH adsorbent. As shown in FIG. 3, the observed reversible lithium capacity was only about 0.51 g/L.

Example 2. This example demonstrates that the invention disclosed significantly improves the lithium deintercalation from LADH lithium selective adsorbents loaded from strong sulfate solutions.

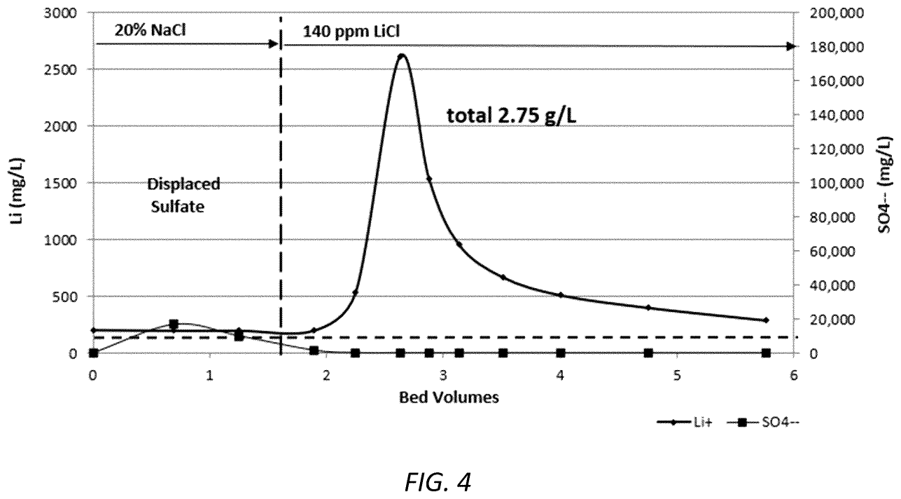

The jacketed glass column from Example 1, which was loaded with lithium from the strong sulfate brine solution, was then fed with a 20% NaCl solution with a pH of 6.8 at 74° C. for 1.5 BV at a flow rate of 25 ml/min (6.0 BV/hr) to initiate a sulfate-to-chloride salt metathesis. The breakthrough curve was monitored for sulfate, and a significant self-sharpened wave release of sulfate from the adsorbent was observed, demonstrating the effectiveness of NaCl in displacing bound sulfate from the LADH adsorbent. Next, water having 140 mg/kg lithium as lithium chloride at 74° C. was passed through the adsorbent bed at a flow rate of 20 mL/min (4.8 BV/hr) to elute additional lithium from the LADH adsorbent. As illustrated in FIG. 4, the breakthrough curve indicated an additional 2.2 g/L of lithium was deintercalated after sulfate bound in the LADH adsorbent was displaced with NaCl, resulting in a combined total reversible lithium capacity of 2.75 g/L from Example 1 and Example 2. This result demonstrates the effectiveness of the inventive process and circuit, which clears the way for LADH adsorbents to be used in the selective recovery of lithium from high multivalent solutions, such as those commonly encountered in hard-rock lithium processing and battery metal recycling.

For purposes of the instant disclosure, the term “at least” followed by a number is used herein to denote the start of a range beginning with that number (which may be a range having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%.

Terms of approximation (e.g., “about”, “substantially”, “approximately”, etc.) should be interpreted according to their ordinary and customary meanings as used in the associated art unless indicated otherwise. Absent a specific definition and absent ordinary and customary usage in the associated art, such terms should be interpreted to be ±10% of the base value.

When, in this document, a range is given as “(a first number) to (a second number)” or “(a first number)-(a second number)”, this means a range whose lower limit is the first number and whose upper limit is the second number. For example, 25 to 100 should be interpreted as a range whose lower limit is 25 and whose upper limit is 100. Additionally, it should be noted that where a range is given, every possible subrange or interval within that range is also specifically intended unless the context indicates the contrary. For example, if the specification indicates a range of 25 to 100, such range is also intended to include subranges such as 26-100, 27-100, etc., 25-99, 25-98, etc., as well as any other possible combination of lower and upper values within the stated range, e.g., 33-47, 60-97, 41-45, 28-96, etc. Note that integer range values have been used in this paragraph for purposes of illustration only, and decimal and fractional values (e.g., 46.7-91.3) should also be understood to be intended as possible subrange endpoints unless specifically excluded.

It should be understood that the exemplary embodiments described above should be considered in a descriptive sense only and not for purposes of limitation. Descriptions of features or aspects within these embodiments should typically be considered as available for other similar features or aspects in other embodiments.

While one or more embodiments have been described with reference to the figures, it will be understood by those of ordinary skill in the art that various changes in form and details may be made therein without departing from the scope of the inventive concept as defined by the following claims.

What is claimed is:

1. A process for selective recovery of lithium from a strong multivalent feedstock solution, the process comprising the steps of:
concentrating the lithium in the feedstock solution by cyclically and sequentially flowing the feedstock solution through a continuous countercurrent adsorption and desorption circuit to form an enhanced lithium product stream, wherein the continuous countercurrent adsorption and desorption circuit comprises a central multi-port valve system a plurality of process zones, wherein each process zone comprises an adsorbent bed or column containing a lithium selective adsorbent, wherein the plurality of process zones further comprises:
a monovalent displacement zone positioned upstream with respect to fluid flow of and in fluid communication with a multivalent displacement zone;
the multivalent displacement zone positioned upstream with respect to fluid flow of and in fluid communication with an adsorption loading zone;
the adsorption loading zone positioned upstream with respect to fluid flow of and in fluid communication with a strip displacement zone;
the strip displacement zone positioned upstream with respect to fluid flow of and in fluid communication with a lithium product strip zone; and
the lithium product strip zone in fluid communication with the monovalent displacement zone,
recovering the lithium from the enhanced lithium product stream.

2. The process of claim 1, wherein the strong multivalent feedstock solution comprises a leachate solution from ore, hard rock, clay, or spodumene, a solution from a battery recycling process, mother liquors, a pregnant leach or liquor solution, or any other multivalent anion-containing lithium solution.

3. The process of claim 2, wherein the strong multivalent feedstock solution is a strong sulfate feedstock solution.

4. The process of claim 3, wherein the strong sulfate feedstock solution has a concentration of about 15% to about 25% sulfate.

5. The process of claim 3, wherein the strong sulfate feedstock solution has a concentration of greater than about 25,000 mg/kg of sulfate.

6. The process of claim 5, wherein the strong sulfate feedstock solution has a concentration of between about 50,000 mg/kg and about 150,000 mg/kg of sulfate.

7. The process of claim 1, wherein the strong multivalent feedstock solution has a temperature of about 5° C. to about 100° C.

8. The process of claim 7, wherein the strong multivalent feedstock solution has a temperature of about 5° C. to about 50° C.

9. The process of claim 7, wherein the strong multivalent feedstock solution has a temperature of about 50° C. to about 100° C.

10. The process of claim 1 further comprises the steps of:
a. eluting the strong multivalent feedstock solution from the adsorbent bed or column containing the lithium selective adsorbent in the monovalent displacement zone with a strong monovalent salt solution to covert bound multivalent ions to monovalent ions; and
b. eluting the adsorbent bed or column containing the lithium selective adsorbent in the monovalent displacement zone with a low salt aqueous solution.

11. The process of claim 10, wherein the strong monovalent salt solution is between about 10% and about 30% strong monovalent salt solution.

12. The process of claim 11, wherein the strong monovalent salt solution is about 20% strong monovalent salt solution.

13. The process of claim 11, wherein the strong monovalent salt solution is a sodium chloride salt solution, a potassium chloride salt solution, or a combination thereof.

14. The process of claim 10, wherein step a. comprises the steps of:
a) displacing the strong multivalent feedstock solution from a freshly loaded adsorbent bed or column in the monovalent displacement zone using an elution volume of a lithium-containing eluant solution or a portion of a lithium product eluate from the lithium product strip zone to a monovalent solution vessel;
b) displacing bound multivalent ions from the adsorbent bed or column in the multivalent displacement zone using a strong monovalent solution from the monovalent solution vessel;
c) displacing an elution volume of a strong multivalent displacement solution from the adsorbent bed or column in the multivalent displacement zone to a combined high multivalent solution vessel;
d) passing a combined strong multivalent feedstock solution/strong multivalent displacement solution through the adsorption loading zone with a predetermined contact time sufficient to completely or almost completely load the adsorbent bed or column in the adsorption loading zone and forming a lithium-depleted, high multivalent raffinate;
d) displacing a latent eluate solution from the adsorbent bed or column in the strip displacement zone with a portion of the lithium-depleted, high multivalent raffinate from the adsorbent loading zone and into a lithium product strip zone;
e) flowing a lithium strip solution through the lithium product strip zone stripping a portion of lithium adsorbed on the adsorbent bed or column in the lithium product strip zone; and
f) collecting a portion of the eluant having high lithium concentration as the enhanced lithium product solution.

15. The process of claim 14 wherein the lithium product eluate comprises neutral salts and water at a concentration of up to about 1000 mg/kg lithium and at a temperature of between about 5° C. to about 100° C.

16. The process of claim 1 further comprises the step of selectively converting the lithium chloride in the enhanced lithium product stream to lithium carbonate, lithium hydroxide, or both.

17. A continuous countercurrent adsorption desorption circuit configured for the selective adsorption and recovery of lithium from a strong multivalent feedstock solution, the circuit comprising:
a central multi-port valve system having a plurality of process zones, each of the process zones comprising a plurality of adsorbent beds or columns having a lithium selective adsorbent; wherein the plurality of process zones further comprises:
a monovalent displacement zone positioned upstream with respect to fluid flow of and in fluid communication with a multivalent displacement zone;
the multivalent displacement zone positioned upstream with respect to fluid flow of and in fluid communication with an adsorption loading zone;
the adsorption loading zone positioned upstream with respect to fluid flow of and in fluid communication with a strip displacement zone;
the strip displacement zone positioned upstream with respect to fluid flow of and in fluid communication with a lithium product strip zone; and
the lithium product strip zone in fluid communication with the monovalent displacement zone.

18. The circuit of claim 17, wherein the strong multivalent feedstock solution comprises a leachate solution from ore, hard rock, clay, or spodumene, a solution from a battery recycling process, mother liquors, a pregnant leach or liquor solution, or any other multivalent anion-containing lithium solution.

19. The circuit of claim 18, wherein the strong multivalent feedstock solution is a strong sulfate feedstock solution having a concentration of greater than about 25,000 mg/kg sulfate.

20. The circuit of claim 1, further comprising:
a strong monovalent solution vessel in fluid communication with the adsorbent bed or column in the monovalent displacement zone and the adsorbent bed or column in the multivalent displacement zone;
a combined strong multivalent feedstock solution/strong multivalent displacement solution vessel in fluid communication with the adsorbent bed or column in the multivalent displacement zone and the adsorbent bed or column in the adsorption loading zone;
a lithium-depleted, high multivalent solution vessel in fluid communication with the adsorbent bed or column in the adsorption loading zone and the adsorbent bed or column in the strip displacement zone;
a lithium strip solution vessel in fluid communication with the adsorbent bed or column in the strip displacement zone and the adsorbent bed or column in the lithium product strip zone; and
an enhanced lithium product solution vessel in fluid communication with the adsorbent bed or column in the lithium product strip zone and with the adsorbent bed or column in the monovalent displacement zone.
